(19) United States
(12) Patent Application Publication
(10) Pub. No.: US 2003/0200505 A1
(43) Pub. Date: Oct. 23, 2003

(54) Method and apparatus for overlaying a source text on an output text

(76) Inventor: David A. Evans, Pittsburgh, PA (US)

Correspondence Address: Blaney Harper, Esq., Jones Day, 51 Louisiana Avenue, N.W., Washington, DC, 20001-2113, US

(21) Appl. No.: 10/439,125

(22) Filed: May 14, 2003

Related U.S. Application Data
(63) Continuation of application No. 08/900,785, filed on Jul. 25, 1997, now abandoned.

(51) Int. Cl. G06F 15/00

(52) U.S. Cl. 715/507; 715/530; 715/500

(57) ABSTRACT

A document image that is the source of Optical Character Recognition (OCR) output is described. Words from a source text are overlaid on words in the output text. Preferably, a user can select a region of the displayed document image. When the region is selected, a word of the OCR output corresponding to the selected region is displayed in a pop-up menu. The invention also permits a text appearing in one language to be overlaid on another text that represents a translation thereof.

### FIELD OF THE INVENTION

The present invention relates to the field of optical character recognition and computerized translation devices. More particularly, this invention relates to a method and apparatus for overlaying a source text on an output text.

### BACKGROUND OF THE INVENTION

Acquisition of text and graphics from paper documentation is a significant issue among many industries. For example, a publishing company may print hundreds or thousands of academic papers over the course of a year. Often the publishing company works from paper documents, which must be inputted into the computer equipment of the publishing company. One conventional approach is to hire keyboardists to read the paper documents and type them into the computer system. However, keying in documents is a time-consuming and costly procedure.

Optical character recognition (“OCR”) is a technology that promises to be beneficial for the publishing industry and others, because the input processing rate of an OCR device far exceeds that of a keyboardist. Thus, employees of the publishing company often work from scanned documents, which are converted into a computer-readable text format, such as ASCII, by an OCR device. However, even the high recognition rates that are possible with modern OCR devices (which often exceed 95%) are not sufficient for such industries as the publishing industry, which demands a high degree of accuracy. Accordingly, publishing companies often hire proofreaders to review the OCR output by hand.

Proofreading OCR output by hand, however, is very time consuming and difficult for people to do. A person must comb through both the original paper document and a print out or screen display of the OCR output and compare them word-by-word. Even with high recognition rates, persons proofreading the OCR output are apt to become complacent and miss errors in the text.

Another conventional option is to spell check the resultant computer-readable text. However, not all recognition errors result in misspelled words. In addition, an input word may be so garbled that the proofreader must refer back to the paper text during the spell-checking operation. Once the proofreader has looked at the paper text and determined the correct word, the correct word must then be keyed into the OCR output text. Because this approach has been found to be time-consuming and somewhat error-prone, it would be useful to enable the proofreader to compare text appearing in a document image along with the OCR interpretation of that text without requiring the proofreader to refer to the original document that was used to generate the OCR interpretation.

Viewing the document image along with the OCR interpretation of that text is particularly useful in situations where the publisher desires to republish and sell the OCR output text not in paper form, but as ASCII text. When a publisher obtains an OCR output for the purpose of reselling it in electronic form, the OCR output must not only contain the correct words, but there is an added concern that the form of the OCR output remain identical to that of the document image when the OCR output is later displayed on a computer monitor. Allowing the proofreader to compare the OCR output and the document image side-by-side during the editing stage furthers this objective considerably.

In addition to proofreading, original paper documents often contain text in foreign languages. The OCR device reads the images from an original text and then displays the OCR output in the same language that appeared in the original text. This foreign-language OCR output can then be translated from one language to another using a variety of commercially available computer translation devices. However, if the reader wants to compare the computer-generated translation of the foreign-language OCR output with the original text to ensure that a proper translation has been obtained, the reader must still refer to two documents (i.e., the original text and the computer-generated translation of that text).

Moreover, many electronic mail messages are transmitted over the internet or other networks in a foreign language to recipients who prefer to review such messages in their native languages. Although these messages, too, can be translated into any given native language using a variety of commercially available computer translation devices, recipients of such messages may still want to compare the original foreign-language text with the translated version thereof to confirm the accuracy of the computer-generated translation. Requiring readers of translated electronic mail messages to refer to more than one document (i.e., the original text and the computer-generated translation thereof) or separate textual passages can be a time-consuming and inefficient process.

### OBJECTS OF THE INVENTION

It is an object of the present invention to overlay a source text on an output text.

It is another object of the invention to enable the user to compare text appearing in a document image along with an OCR interpretation of that text without requiring the user to refer to the original document that was used to generate the OCR interpretation.

It is yet another object of the invention to enable the user to compare text appearing in a document image with the OCR interpretation of that text for the purpose of correcting errors that occurred during the conversion of the source text to the OCR output text.

It is still another object of the invention to enable the user to view text appearing in one language along with a translated version thereof without requiring the user to refer to more than one document or separate passages.

### SUMMARY OF THE INVENTION

There exists a need for facilitating human proofreading of OCR output. Moreover, there exists a need for enabling readers to view text appearing in one language along with a translated version thereof without requiring the user to refer to more than one document or separate passages.

To facilitate human proofreading of OCR output, a document image is created from an original paper document and recognized (e.g., through OCR) to produce a document text. Regions in the document image that correspond to words in the document text are determined using a correlation table, and each region from the document image is then displayed adjacent to the corresponding words from the document text. The user can then select a word in the document text and obtain a pop-up menu displaying possible replacement words.

To enable readers of text appearing in one language to view the translation of that text in another language without having to refer to more than one document or separate passages, a document text is received and each word therein translated to produce a translated word for every word in the document text. Each translated word is then displayed adjacent to each corresponding word in the document text. The user can then select a word in the document text and obtain a pop-up menu displaying other translations of the translated word.

These and other aspects and advantages of the present invention will become better understood with reference to the following description, drawings, and appended claims.

### BRIEF DESCRIPTION OF THE DRAWINGS

The invention will be described in detail with reference to the following drawings in which like reference numerals refer to like elements and wherein:

FIG. 1 is a high-level block diagram of a computer system with which the present invention can be implemented.

FIG. 2(a) is a block diagram of the architecture of a compound document.

FIG. 2(b) is a flow chart illustrating the operation of creating a compound document.

FIG. 3(a) is an exemplary screen display according to one embodiment of the present invention.

FIG. 3(b) is an exemplary screen display according to an alternative embodiment of the present invention.

FIG. 4 is a flow chart illustrating the operation of error correction of OCR output according to an embodiment of the invention.

### DETAILED DESCRIPTION OF THE INVENTION

### 1. Hardware Overview

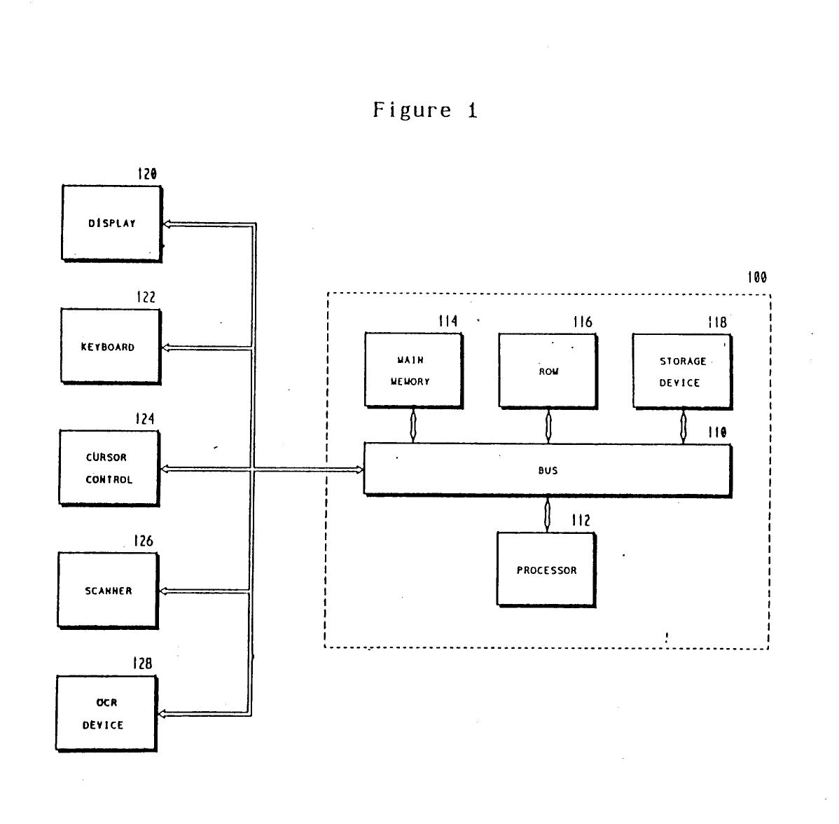

FIG. 1 is a block diagram of a computer system 100 upon which an embodiment of the present invention can be implemented. Computer system 100 includes a bus 110 or other communication mechanism for communicating information, and a processor 112 coupled with bus 110 for processing information. Computer system 100 further comprises a random access memory (RAM) or other dynamic storage device 114 (referred to as main memory), coupled to bus 110 for storing information and instructions to be executed by processor 112. Main memory 114 also may be used for storing temporary variables or other intermediate information during execution of instructions by processor 112. Computer system 100 also comprises a read only memory (ROM) and/or other static storage device 116 coupled to bus 110 for storing static information and instructions for processor 112. A data storage device 118, such as a magnetic disk or optical disk and its corresponding disk drive, can be coupled to bus 110 for storing information and instructions.

Input and output devices can also be coupled to computer system 100 via bus 110. For example, computer system 100 uses a display unit 120, such as a cathode ray tube (CRT), for displaying information to a computer user. Computer system 100 further uses a keyboard 122 and a cursor control 124, such as a mouse. In addition, computer system 100 may employ a scanner 126 for converting paper documents into a computer-readable format. Furthermore, computer system 100 can use an OCR device 128 to recognize characters in a document image produced by scanner 126 or stored in main memory 114 or data storage device 118. Alternatively, the functionality of OCR device 128 can be implemented in software, by executing instructions stored in main memory 114 with processor 112. In yet another embodiment, scanner 126 and OCR device 128 can be combined into a single device configured to both scan a paper document and recognize characters thereon.

The present invention is related to the use of computer system 100 for viewing a source text and an output text on the same display unit 120. According to one embodiment, this task is performed by computer system 100 in response to processor 112 executing sequences of instructions contained in main memory 114. Such instructions may be read into main memory 114 from another computer-readable medium, such as data storage device 118. Execution of the sequences of instructions contained in main memory 114 causes processor 112 to perform the process steps that will be described hereafter. In alternative embodiments, hard-wired circuitry may be used in place of or in combination with software instructions to implement the present invention. Thus, the present invention is not limited to any specific combination of hardware circuitry and software.

### 2. Compound Document Architecture

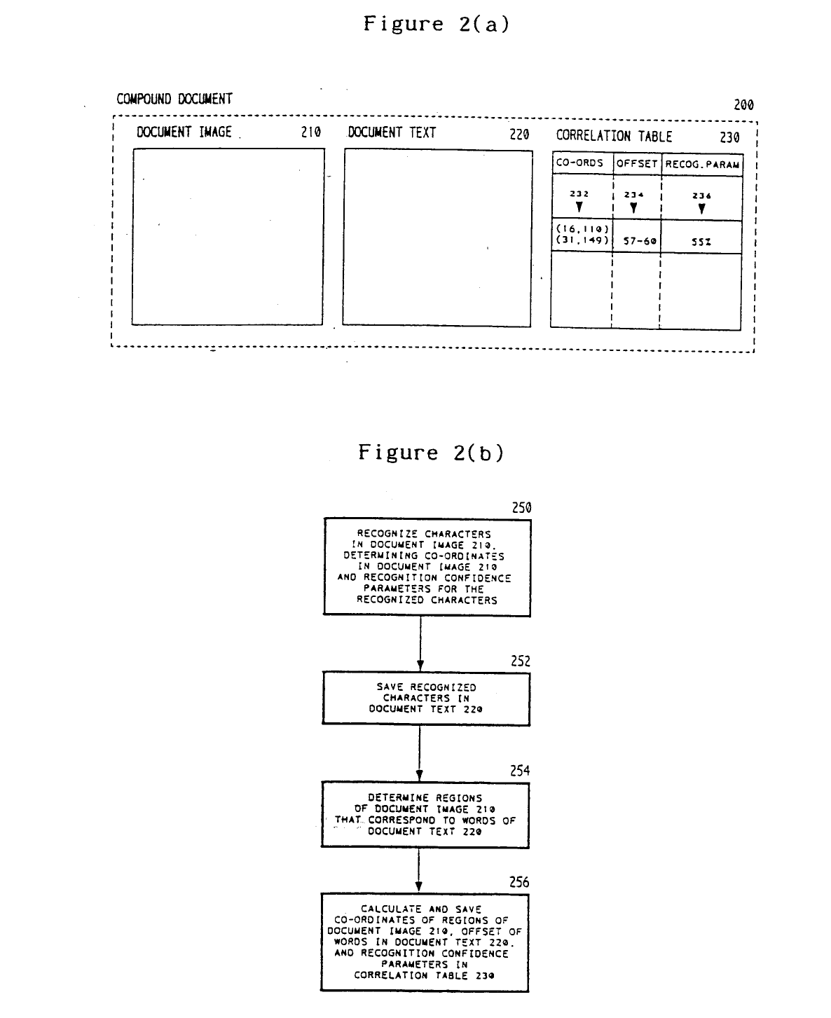

A compound document contains multiple representations of a document and treats the multiple representations as a logical whole. A compound document 200, as reflected in FIG. 2(a), is stored in a memory, such as main memory 114 or data storage device 118 of computer system 100.

Compound document 200 comprises a document image 210, which is a bitmap representation of a document (e.g., a TIFF file produced from scanner 126). For example, a copy of the U.S. Constitution on paper may be scanned by scanner 126 to produce an image of the Constitution in document image 210.

A bitmap representation is an array of pixels, which can be monochrome (e.g., black and white) or polychrome (e.g., red, blue, green, etc.). The location of a rectangular region in the document image 210 can be identified, for example, by the coordinates of the upper left corner and the lower right corner of the rectangle. In the example of scanning the U.S. Constitution, the first character of the word “form” in the Preamble (i.e., “f”), may be located in the document image 210 in a rectangle with an upper left coordinate of (16, 110) and a lower right coordinate of (31, 119), and the last of character of the same word (i.e., “m”) could be located in the document image 210 with the coordinates (16, 140) and (31, 149).

Compound document 200 also comprises a document text 220 and a correlation table 230, which may be produced by the method illustrated in the flow chart of FIG. 2(b). A document text 220 is a sequence of 8-bit or 16-bit bytes that encode characters in an encoding such as ASCII, EBCDIC, or Unicode. Thus, characters in the document text 220 can be located by offsets into the document text 220. In the example, the first character of the word “form” in the Preamble may be located in the document text 220 at offset 57, and the last character of the same word could be located in the document text 220 at offset 60, as reflected in the offset column of the correlation table 230.

Referring to FIG. 2(b), characters in document image 210 are recognized in step 250, by OCR device 128 or an equivalent thereof, and saved in step 252 to produce document text 220. OCR device 128 is also configured to output in step 250 the coordinates in the document image 210 of the characters that are recognized. Thus, recognized characters at a known offset in the document text 220 can be correlated with regions of the document image 210. In the example of an image of the Preamble, the first character of the word “form” in the document text 220 (which is set at offset 57) is correlated with the document image 210 region defined by the coordinates (16, 110) and (31, 119). Similarly, the last character of the word “form” in the document text 220 (which is set at offset 60) is correlated with the document image 210 region defined by the coordinates (16, 140) and (31, 149).

In step 254, words in the document text 220 are identified, for example, by taking the characters between spaces as words. In step 254, the regions in the document image 210 that correspond to the characters of each of these words are merged into larger document image 210 regions that correspond to each word of the document text 220. In one embodiment, the region of document image 210 is defined as a rectangle with the most upper left coordinate and the most lower right coordinate of the coordinates of the regions corresponding to the individual words of document text 220. For example, the region of document image 210 corresponding to the word “form” in the document text 220 (offsets 57-60) is defined by a rectangle with the coordinates (16, 110) and (31, 149), as reflected in the coordinate and offset columns of the correlation table 230. Alternatively, a list of the coordinates for each character of document text 220 and their corresponding document image 210 regions may be saved individually, especially for documents with mixed-size characters.

In addition, some implementations of OCR device 128, known in the art, are configured to output a recognition confidence parameter that measures the probability that a word or phrase in the document text 220 contains an improper OCR recognition. For example, with certain fonts, the letter “m” in document image 210 might be recognized by the OCR device 128 as the letter combination “rn” (the OCR device 128 might output a low recognition confidence parameter for the word “modem”, for instance, because the OCR device could interpret that word as “modern”). Consequently, words that contain the letter “m” are likely to be assigned a relatively lower confidence score than words comprised entirely of unique characters. In the above example of the Preamble, the word “form” might be assigned a recognition confidence parameter of 55% because of the existence of the character “m” in that word.

In step 256, information about each word appearing in document text 220 is saved in correlation table 230, so that regions of document image 210 can be correlated with words in document text 220. Specifically, correlation table 230 stores a pair of coordinates 232 defining a region in document image 210, a pair of offsets 234 defining a word in document text 220, and a recognition confidence parameter 236 for the word. In the example, the word “form” in document text 220 would have a pair of coordinates 232 of (16, 110) and (31, 149), a pair of offsets 234 of 57 and 60, and a recognition confidence parameter 236 of 55%.

Using the correlation table 230, every offset in document text 220 corresponds to a region of document image 210, and vice versa. For example, given a character in document text 220 at offset 58, the offset column of correlation table 230 can be surveyed to determine that the character corresponds to the rectangular region in document image 210 with coordinates of (16, 110) and (31, 149). The region in document image 210 at those coordinates (in the example, the word “form”) can then be fetched from document image 210 and displayed. In the other direction, given a document image 210 coordinate of (23, 127), the coordinate column of the correlation table 230 can be surveyed to determine that the given document image 210 coordinate is found within a word in the document text 220 having offsets of 57-60. The word at that offset range in document text 220 (in the example, the word “form”) can then be identified. Thus, the compound document architecture described herein provides a way of correlating the location of words in the document text 220 with corresponding regions of the document image 210.

### 3. Overlaying Words from a Source Text on an Output Text

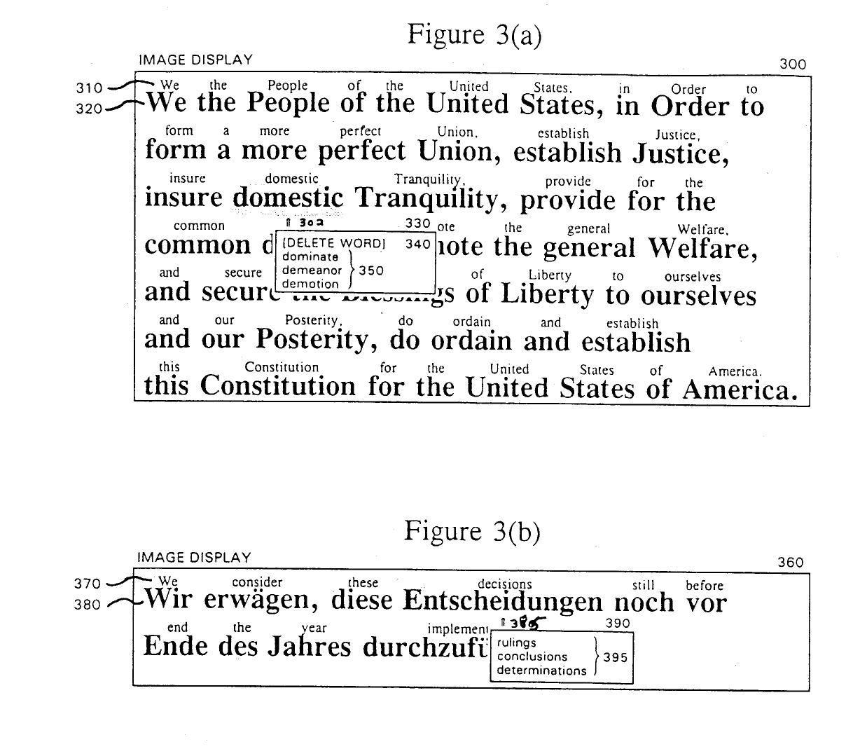

In order to reduce the time involved in consulting the original paper document, the scanned image of the original paper document (i.e., document image 210) is displayed to the proofreader along with the OCR interpretation of that text. In the example of scanning the U.S. Constitution, the scanned image of the Preamble may be displayed in image display 300 as shown in FIG. 3(a).

In the image display 300, regions from the document image 210 are overlaid adjacent to (e.g., above, below, superscript, subscript, etc.) the words from the document text 220 to which the regions correspond. As reflected in FIG. 3(a), for example, the first word in the Preamble “We” 310 from the document image 210 is displayed to the user so that it appears directly over the corresponding word 320 from the document text 220. This is accomplished by correlating the location of each word from the document text 220 with a corresponding region of the document image 210 using the correlation table 230 as described above. Once a region in the document image 210 has been correlated with a word in the document text 220, the region of the document image 210 is fetched and displayed adjacent to the corresponding word of the document text 220. This procedure is performed repeatedly until each region appearing in the document image 210 has been displayed adjacent to its corresponding word from the document text 220. The user can then view this display by utilizing the display unit 120 or by obtaining a print-out of the overlay.

Alternatively, the words overlaid adjacent to (e.g., above, below, superscript, subscript, etc.) the words from the document text 220 are displayed based on the recognition confidence parameters 236 received from the OCR device 128. In this embodiment, regions in document image 210 corresponding to words having a recognition confidence parameter 236 below a certain threshold can be displayed adjacent to the words of the document text 220. For example, the threshold could be set at 60%, and because the original word “form” is assigned a recognition confidence parameter 236 of 55%, the region in the document image 210 corresponding to that word is displayed adjacent to the word “form” in document text 220.

In another embodiment, a particular overlaid word is selected from a list of possible replacement words that could have produced the recognized text. A wide variety of techniques for generating possible replacement words are known in the art, but the contemplated invention does not require any particular technique. For example, a letter-level phenomena (i.e., probabilities that a letter or pairs of letters would be misrecognized as another letter) can be employed to generate possible replacement words. As another example, word-level behavior can be taken into account for generating possible replacement words, for example, by spell checking. As still another example, phrase-level information (e.g., a Markov model of extant sequences of words in a database) can be used. Moreover, these various techniques can be combined and weighted. Preferably, however, the word that most likely would be used as a replacement for the word appearing in the document text 220 is selected as the word or text to be overlaid.

### 4. Error Correction of OCR Output

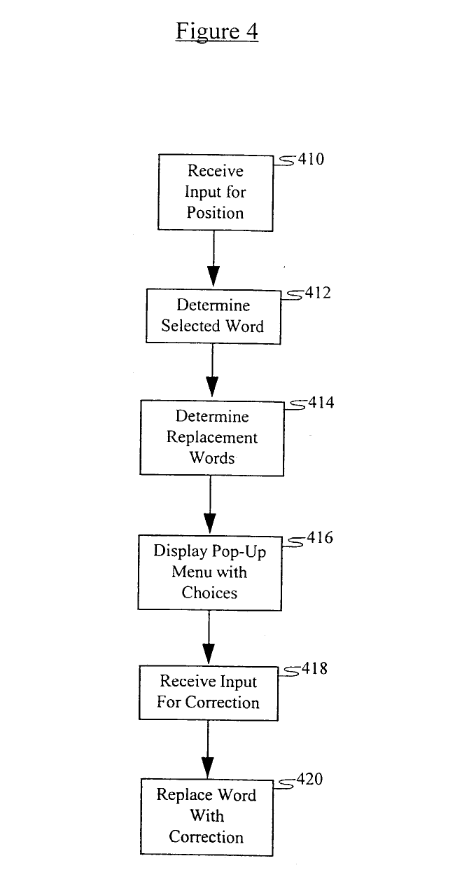

The operation of error correction of OCR output according to an embodiment of the invention is illustrated in the flow chart of FIG. 4. To effect a correction, a cursor 302 is positioned over any part of the document text 220 using the cursor control 124, such as a mouse, track-ball, or joy-stick.

In step 410, the processor 112 receives input from cursor control 124 regarding the position of cursor 302 on the image display 300. This input can be automatically generated by cursor control 124 whenever the cursor 302 is positioned over image display 300, or only when the user activates a button. In the latter case, when the user activates a button, the cursor control 124 sends the current position of the cursor 302 as input.

The position of cursor 302 identified with the input received in step 410 is converted from the coordinate system of the image display 300 into the offset system of the document text 220, according to mapping techniques well-known in the art. In the example illustrated in FIG. 3(a), the position of cursor 302 in image display 300 may correspond to offset 59 of document text 220.

In step 412, the correlation table 230 is surveyed for an entry specifying an offset pair 234 that encompasses the offset derived from input received in step 410. In the example, offset 59 is encompassed by the offset pair 57-60. This pair is used to extract a string of characters positioned in document text 220 at the offsets in the offset range 234.

In step 414, possible replacement words for the character string at offsets 57-60 are generated. As stated previously, a wide variety of techniques for generating possible replacement words are known in the art, but the contemplated invention does not require any particular technique. In the example, step 414 may generate the following set of possible replacement words for the selected text “domestic”: “dominate”, “demeanor”, and “demotion”.

In step 416, possible replacement words for the selected text are displayed in a pop-up menu 330 near the cursor 302 when the user clicks on a mouse button or presses a similar function key. It is preferred that these replacement words be displayed in pop-up menu 330 in rank order according to the likelihood of their potential replacement of the selected text (i.e., the replacement at the top of the list in pop-up menu 330 will most likely be used as a replacement if the selected text is deemed incorrect). In one embodiment, a delete option 340 is also provided in pop-up menu 330 near the cursor 302 for the purpose of enabling the user-to delete portions of the document text 220 on the fly.

According to another embodiment, when the cursor 302 is positioned over a word in the document text 220, a pop-up menu 330 for the selected text is automatically displayed. Thus, a user can sweep the cursor 302 over displayed lines of text in document text 220 and quickly compare the selected text with potential replacements in pop-up menu 330.

When the pop-up menu 330 is displayed, the user may decide by looking at the overlaid document image 210 regions that the selected text in the document text 220 is not correct. In this case, the user would look at the possible replacement words in pop-up menu 330 for the correct replacement word. If the correct replacement word is found, then the user can select the correct replacement (e.g., by highlighting the appropriate word and clicking or letting go a button of the cursor control 124). In the example, the correct replacement for the word “domestic” might be “demeanor”, displayed between “dominate” and “demotion” in the pop-up menu 330.

At this point, the processor 112 receives input for the intended correction as in step 418 and replaces the word in the document text 220 with the user-selected correction as in step 420. However, if the correct replacement word is not present in pop-up menu 330, the user may input the correct replacement word by conventional means (e.g., through keyboard 122). By generating possible replacement words and displaying them in a pop-up menu 330, the time consumed in making corrections to OCR output is reduced. Once the user makes a correction to the document text 220, the correlation table 230 must be updated to reflect that this action occurred.

### 5. Displaying Translation of source Text On An Output Text

As reflected in FIG. 3(b), the application of the present invention to foreign-language text is similar to that of comparing documents appearing in the same language. As in the image display 360, each word in the document text 220 is translated into a user-selected language using a machine translation device and stored in a memory such as main memory 114 or data storage device 118. The processor 112 then retrieves the first translation corresponding to the first word appearing in the document text 220 and posts the translation adjacent to (e.g., above, below, superscript, subscript, etc.) the first word of the document text 220. This procedure is performed repeatedly for each word appearing in the document text until each translation word has been posted as shown at 370 and 380. The user may then view this display by utilizing the display unit 120 or by obtaining a print-out of the overlay.

In a further embodiment, the user can position the cursor 385 over any given word in the document text 220 and click a mouse button or press a similar function key to obtain a pop-up menu 390 that reveals other possible translations 395 of the selected word, as reflected in FIG. 3(b). In yet another embodiment, the pop-up menu 390 is automatically obtained as soon as the cursor 385 is placed over the selected word without requiring the user to click the mouse button or press a similar function key.

Although the present invention has been described and illustrated in considerable detail with reference to certain preferred embodiments thereof, other versions are possible. Upon reading the above description, it will become apparent to persons skilled in the art that changes in the above description or illustrations may be made with respect to form or detail without departing from the spirit or scope of the invention.

I claim:

1. A method of displaying a text, comprising:
creating a document image from a document;
recognizing characters from said document image to produce a document text;
determining regions of said document image that correspond to words of said document text;
correlating said regions of said document image with corresponding words of said document text using a correlation table; and
displaying said regions of said document image adjacent to said words of said document text.

2. The method of claim 1, wherein said regions of said document image are displayed above said words of said document text.

3. The method of claim 1, wherein said regions of said document image are displayed below said words of said document text.

4. The method of claim 1, wherein only said regions of said document image that fall below a user-selected recognition confidence parameter are displayed adjacent to said words of said document text.

5. The method of claim 1, wherein a word selected from a list of words is displayed adjacent to corresponding said words of said document text instead of said regions of said document image.

6. The method of claim 1, further comprising the steps of:
receiving input that selects a position in said document image;
determining a selected text that corresponds to said position in said document text;
receiving input for correcting said selected text; and
updating said correlation table to reflect corrections made to said selected text.

7. The method of claim 6, wherein the step of receiving input for correcting said selected text includes deleting said selected text.

8. The method of claim 6, wherein the step of receiving input for correcting said selected text includes:
determining one or more replacement words for said selected text;
displaying said one or more replacement words for said selected text;
receiving input that indicates a replacement word for said selected text; and
replacing said selected text with said replacement word.

9. The method of claim 8, wherein the step of receiving input that indicates a replacement word includes the step of receiving keyboard input of said replacement word.

10. The method of claim 8, wherein said one or more replacement words are displayed in a pop-up menu.

11. An apparatus for displaying a text, comprising:
a scanning device for creating a document image of a document;
an optical character recognition device for recognizing characters in a document image to produce a document text;
a processor for
determining regions of said document image that correspond to words of said document text, and
correlating said regions of said document image with corresponding words of said document text using a correlation table; and
a display unit for displaying said regions of said document image adjacent to said words of said document text.

12. The apparatus of claim 11, wherein said display unit is controlled to display said regions of said document image above said words of said document text.

13. The apparatus of claim 11, wherein said display unit is controlled to display said regions of said document image below said words of said document text.

14. The apparatus of claim 11, wherein said display unit is controlled to display only said regions of said document image that fall below a user-selected recognition confidence parameter adjacent to said words of said document text.

15. The apparatus of claim 11, wherein said display unit is controlled to display a word selected from a list of words adjacent to corresponding said words of said document text instead of said regions of said document image.

16. The apparatus of claim 11, further comprising a cursor control for receiving input that selects a position in said document image, and wherein said processor
determines a selected word that corresponds to a region of said document image,
receives input for correcting said selected text, and
updates said correlation table to reflect corrections made to said selected text.

17. The apparatus of claim 16, wherein said processor receives input for correcting said selected text by deleting said selected text.

18. The apparatus of claim 16, wherein said processor receives input for correcting said selected text by
determining one or more replacement words for said selected text,
controlling the display unit to display said one or more replacement words for said selected text,
receiving input that indicates a replacement word for said selected text, and
replacing said selected text with said replacement word.

19. The apparatus of claim 18, further comprising a keyboard for inputting said replacement word for said selected text.

20. The apparatus of claim 18, wherein said display unit is controlled to display said one or more replacement words in a pop-up menu.

21. A method of overlaying a text appearing in one language on another text that represents a translation thereof, comprising:
receiving a document text;
translating each word in said document text to produce a translated word for every word in said document text; and
displaying adjacent to said each word in said document text a translated word that corresponds to said each word in said document text.

22. The method of claim 17, further comprising the steps of:
receiving input that selects a position in said document image;
determining a selected text that corresponds to said position in said document text; and
displaying possible translations of said selected text.
